(19) United States
(12) Patent Application Publication
(10) Pub. No.: US 2002/0081439 A1
(43) Pub. Date: Jun. 27, 2002

(54) Composite elements comprising polyisocyanate polyaddition products

(76) Inventors: Heinz Forster, Wolfratshausen (DE); Matthias Hefner, Erdweg (DE); Georg Knoblauch, Munchen (DE); Jurgen Mertes, Altrip (DE); Peter Reinerth, Emmering (DE); Thomas Sandbank, Munchen (DE); Edmund Stadler, Hollfeld (DE)

Correspondence Address: BASF CORPORATION, LEGAL DEPARTMENT, 1609 BIDDLE AVENUE, WYANDOTTE, MI, 48192, US

(21) Appl. No.: 10/021,879

(22) Filed: Dec. 13, 2001

(30) Foreign Application Priority Data
Dec. 13, 2000 (DE) 10062129.5

(51) Int. Cl. B32B 27/00

(52) U.S. Cl. 428/425.8

(57) ABSTRACT

The invention relates to composite elements which have the following layer structure:

(i) from 2 to 20 mm of metal,

(ii) from 10 to 300 mm of polyisocyanate polyaddition products obtainable by reacting (a) isocyanates with (b) compounds reactive toward isocyanates in the presence of at least one inorganic acid, and also of at least one catalyst (d),

(iii) from 2 to 20 mm of metal.

The invention relates to composite elements which have the following layer structure:

(i) from 2 to 20 mm, preferably from 2 to 10 mm, particularly preferably from 5 to 10 mm, of metal,

(ii) from 10 to 300 mm, preferably from 10 to 100 mm, of polyisocyanate polyaddition products obtainable by reacting (a) isocyanates with (b) compounds reactive toward isocyanates in the presence of at leaast one inorganic acid, and also of at least one catalyst (d),

(iii) from 2 to 20 mm, preferably from 2 to 10 mm, particularly preferably from 5 to 10 mm, of metal.

The invention further relates to a process for producing these composite elements, and to their use.

The structural components used in the design of ships, for example hulls and cargo hold covers, or of bridges, roofs or multistorey buildings, have to be able to withstand considerable stresses from external forces. Due to these requirements structural components of this type are usually composed of metal plates or metal supports, strengthened by appropriate geometry or suitable struts. Due to increased safety standards, tanker hulls therefore are usually composed of an inner and an outer hull, each hull being built up from steel plates of 15 mm thickness, connected to one another via steel struts about 2 m in length. Since these steel plates are exposed to considerable forces, both the outer and the inner steel shells are reinforced by welded-on reinforcing elements. Disadvantages of these traditional structural components are both the considerable amounts of steel required and the time-consuming and labor-intensive method of manufacture. In addition, structural components of this type have considerable weight, reducing the tonnage of the ships and increasing fuel usage. Traditional structural components of this type based on steel also require heavy maintenance, since both the outer surface and the surfaces of the steel components between the outer and the inner shells regularly have to be protected against corrosion.

Known substitutes for designs based on steel are SPS elements (sandwich plate systems), comprising a composite made from metal and plastic. The adhesion of the plastic to the two metal layers produces composite elements with remarkable advantages over known designs based on steel. U.S. Pat. Nos. 6,050,208, 5,778,813, DE-A 198 25 083, DE-A 198 25 085, DE-A 198 25 084, DE-A 198 25 087 and DE-A 198 35 727 disclose SPS elements of this type.

An important factor in producing the composite elements is the reaction of the starting components to prepare (ii). A reaction which is excessively slow or excessively rapid can lead to unusable products, all of which have to be rejected. Their reaction is affected by the quality of the metal plates (i) and (ii), and also by other external effects, such as temperature.

It is an object of the present invention to develop new composite elements where the preparation of the plastics (ii) present takes place in a specified, controlled, and optimized manner, in particular with regard to the reactivity of (a) isocyanates with (b) compounds reactive toward isocyanates.

We have found that this object is achieved by way of the composite elements described at the outset.

In this specification, the inorganic acids are also referred to as “inhibitors”.

Addition of inhibitors has proven advantageous in mixtures of starting components (a) and (b) which have intrinsically high reactivity and therefore short reaction time—as a result of the selection of the polyether polyols and/or chain extenders/crosslinkers, and also of the isocyanates. Adding these inhibitors increases the processing time once the starting components have been mixed, so that even large cavities can be filled. The preferred inhibitors used are phosphoric acid and/or hydrochloric acid, particularly preferably phosphoric acid. When inorganic acids are used rather than carboxylic acids there is no added blowing effect/carbon dioxide formation (reaction of isocyanate with carboxylic acid).

The amount used of the inhibitors is preferably from 0.01 to 2.0% by weight, with preference from 0.1 to 0.5% by weight, based on the weight of the compounds (b) reactive toward isocyanates.

In mixtures of starting components (a) and (b) which intrinsically have low reactivity—due to the selection of the polyether polyols and/or chain extenders/crosslinkers, and also of the isocyanates—catalysts/catalyst mixtures (d) can be used to optimize during performance as appropriate for the size of the mold and the complexity of the cavity, the objective being to give the mixture of starting components sufficiently good flow characteristics while at the same time curing the polyisocyanate polyaddition product as rapidly as possible.

The desired course of curing may also be achieved using mixtures comprising inorganic acids (e.g. phosphoric acid, hydrochloric acid) and using partially or completely neutralized tertiary amines. These salts are catalysts with retardant action which are not highly active at room temperature and therefore permit even large cavities to be filled. Catalytic activity increases rapidly when the exothermic polyurethane reaction begins, and rapid curing of the polyisocyanate polyaddition product is therefore achieved.

Examples of preferred catalysts (d) are:

a) Tertiary amines, e.g.:

1,4-diazabicyclo[2.2.2]octane (DABCO),

1,4-diazabicyclo[2.2.2]octane (DABCO) blocked using organic acids (e.g. formic acid, acetic acid, 2-ethylhexanoic acid) or using inorganic acids (e.g. phosphoric acid, hydrochloric acid),

N,N,N,N-tetramethylpolymethylenediamines having from 2 to 16 carbon atoms, N-methyl-N-dimethylaminoethylpiperazine, thermally activatable catalysts from the class of compounds consisting of the 1,8-diazabicyclo[5.4.0]undec-7-ene (DBU), and also combinations of the abovementioned catalysts with bis(dimethylaminoethyl) ether,

N,N,N,N,N-pentamethyldiethylenediamine, or

N,N,N,N,N-pentamethyldipropylenetriamine, preferably

1,4-diazabicyclo[2.2.2]octane (DABCO) and/or

1,4-diazabicyclo[2.2.2]octane (DABCO) blocked using organic acids (e.g. formic acid, acetic acid, 2-ethylhexanoic acid) or using inorganic acids (e.g. phosphoric acid, hydrochloric acid).

b) well known metallic catalysts, preferably Sn(II) and/or Sn(IV) compounds, such as:

tin dioctoate, diethyltin hexanoate, dimethyltin dilaurate, dibutyltin dilaurate, and in particular sulfur-containing Sn catalysts from the class of compounds consisting of the dialkyltin mercaptides, e.g. dibutyldilauryltin mercaptide, and/or mixtures of monooctyltin tris(2-ethylhexylthioglycolate) and dioctyltin bis(2-ethylhexylthioglycolate), preferably mixtures comprising monooctyltin tris(2-ethylhexylthioglycolate) and/or dioctyltin bis(2-ethylhexylthioglycolate).

Mixtures of tertiary amines and the abovementioned metal catalysts have also proven effective.

The total content of catalysts (d) is preferably from 0.001 to 15% by weight, and in particular from 0.01 to 6% by weight, based on the total weight used of compounds (b) reactive toward isocyanates.

According to the invention, therefore, addition of the advantageous acids, and also of the catalysts (d) is used to optimize the reaction of (a) with (b) with respect to their reactivity, their conversion performance, and their completion of curing. The result is that the reaction takes place in a specified time, even if external conditions change. This method avoids excessively rapid reaction of (a) with (b), and also avoids excessively slow reaction. The specific result of a reaction beginning rapidly would be that the raw materials are unable to occupy all of the space between (i) and (iii) intended for complete filling with (ii). The result of this can be that large areas of the surface of (i) and (iii) have no bonding to one another via (ii). The resultant considerable disadvantages for the static and dynamic properties of the composite elements would be unacceptable.

The invention therefore achieves interaction of inhibitors and catalysts in such a way as to give the system used for preparing (ii) open time which is preferably from 5 minutes to 10 minutes. For the purposes of the present invention, “open time” is the time during which the system comprising (a) and (b) can be processed, i.e. introduced between (i) and (iii).

As (b) the composite elements preferably comprise polyether polyalcohols, particularly preferably polymer polyols.

As (a) the composite elements preferably comprise MDI isocyanate components with functionality greater than 2, preferably with functionality >2.3, and in particular with functionality <2.6. For a given polyol component here, the heat resistance (modulus of elasticity >275 MPa) increases as the functionality of the isocyanate component rises, therefore the stiffness of the elastomer in the SPS can be controlled via the selection of the isocyanate and thus matched to any particular set of requirements. For the purposes of the present invention, MPIs are diphenylmethane diisocyanates. The term functionality refers to the average number of isocyanate groups per molecule. These isocyanate components are mixtures of diphenylmethane diisocyanates and polyphenyl polymethylene polyisocyanates, the content of MDI derivatives having 3, 4 or more rings (polyphenyl polymethylene polyisocyanates) being >10%, in particular >30%, and with preference >50%, based in each case on the total weight of the mixture.

Preference is given to composite elements obtainable by reacting (a) with (b) in the presence of inorganic acids (d), and from 1 to 50% by volume of gases (c).

Preference is given to composite elements obtainable by reacting (a) with (b) in the presence of inorganic acids, (d), and (f) blowing agents.

Particular preference is given to composite elements which have the following layer structure:

(i) from 2 to 20 mm, preferably from 2 to 10 mm, particularly preferably from 5 to 10 mm, of metal,

(ii) from 10 to 300 mm, preferably from 10 to 100 mm, of polyisocyanate polyaddition products with density from 350 to 1100 kg/m³, obtainable by reacting (a) isocyanates with (b) compounds reactive toward isocyanates in the presence of at least one inorganic acid, of (d) catalysts, and also, where appropriate, of (f) blowing agents, and of from 1 to 50% by volume, based on the volume of the polyisocyanate polyaddition products, of at least one gas (c), and/or of (e) auxiliaries and/or additives,

(iii) from 2 to 20 mm, preferably from 2 to 10 mm, particularly preferably from 5 to 10 mm, of metal.

The polyisocyanate polyaddition products (ii) of the composite elements produced according to the invention preferably have a modulus of elasticity >275 MPa in the temperature range from −45 to +90° C. (to DIN 53 457), adhesion to (i) and (iii) of >4 MPa (to DIN 53 530), extension of >30% in the temperature range from −45 to +90° C. (to DIN 53504), tensile strength of >20 MPa (to DIN 53504), and compressive strength of >20 MPa (to DIN 53421).

A particular advantage of the preferred composite elements, alongside excellent mechanical properties, is that the composite elements which can be obtained include elements with very large dimensions. It has been difficult hitherto to produce composite elements of this type by preparing a plastic (ii) between two metal plates (i) and (iii), since the plastic (ii) shrinks during and after its transfer. The shrinkage of the plastic (ii), for example of the polyisocyanate polyaddition products, causes partial break-away of the plastic (ii) from the metal plates (i) and/or (iii). However, very complete and very good adhesion of the plastic (ii) to the metal plates (i) and/or (iii) is a specific factor of high importance for the mechanical properties of a composite element of this type. The shrinkage can be markedly decreased by using (f) blowing agents (c) gases, and/or polymer polyols as (b).

One method of producing the composite elements of the invention is to prepare polyisocyanate polyaddition products (ii), usually polyurethanes which may, where appropriate, have urea structures and/or isocyanurate structures, between (i) and (iii) by reacting (a) isocyanates with (b) polymer polyols in the presence of at least one inorganic acid, of (d) catalysts, and preferably in the presence of blowing agents (f), and preferably in the presence of from 1 to 50% by volume, based on the volume of the polyisocyanate polyaddition products, of at least one gas (c), and preferably in the presence of (e) auxiliaries and/or additives, where the polyisocyanate polyaddition products adhere to (i) and (iii).

The reaction is preferably carried out in a closed mold, for example using (i) and (iii) as outer layers, so that when the mold is filled (i) and (iii) are in the mold together with the starting components for producing (ii), and the mold is sealed when all of the starting components have been introduced. Once the starting components have been reacted to produce (ii) the composite element may be demolded.

It is preferable to sand-blast those surfaces of (i) and/or (iii) to which (ii) adheres once the composite elements have been produced. Usual processes may be used for this sand-blasting. For example, the usual sand may be used to sand-blast the surfaces at high pressure, thus, for example, cleaning and roughening the surfaces. Suitable equipment for a treatment of this type is commercially available.

This treatment of those surfaces of (i) and (iii) which are in contact with (ii) once (a) has been reacted with (b) can give markedly improved adhesion of (ii) to (i) and (iii). The sand-blasting is preferably carried out directly prior to the introduction of the components used for producing (ii) into the space between (i) and (iii). The surfaces to which (ii) is to adhere on (i) and (iii) are preferably free from inorganic and/or organic substances which reduce adhesion, for example oils or fats, or generally any substance known to be a mold-release agent.

To produce the composite elements, for example after the preferred treatment of the surfaces of (i) and (iii), these layers are preferably fixed in a suitable arrangement, for example parallel to one another. The distance selected is usually such that the space between (i) and (iii) has a thickness of from 10 to 100 mm. (i) and (iii) may be fixed by way of spacers, for example. It is preferable for the edges of the intervening space to be sealed off in a way which allows the space between (i) and (iii) to be charged with (a), (b) and (d), and also, if desired, (f) and/or (e) and/or (c), but prevents these components from escaping. For the sealing-off use may be made of the usual plastics films or metal films and/or metal plates, and these may also serve as spacers.

The layers (i) and (iii) used may preferably be the usual metal plates, such as steel plates, with the thicknesses according to the invention.

When the space between (i) and (iii) is filled, (i) and (iii) may be vertical or horizontal.

The usual conveying equipment, such as high- or low-pressure machinery, preferably high-pressure machinery, may be used to fill the space between (i) and (iii), preferably continuously, with (a), (b) and, where appropriate, with the other starting materials.

The conveying rate may be varied as a function of the volume to be filled. In order to ensure uniform through-curing of (ii), the conveying rate and conveying equipment selected is such that the space to be filled can be filled within a period of from 0.5 to 20 min with the components for producing (ii).

The layers (i) and (iii) used are usually plates and may be the usual metals, such as iron, conventional steel, any type of refined steel, aluminum and/or copper.

When producing the novel composite elements, either (i) or else (iii) may be used in coated form, for example primed, otherwise surface-coated and/or coated with conventional plastics. (i) and (iii) are preferably used uncoated, and particularly preferably, for example, after cleaning by conventional sand-blasting.

The preparation of the polyisocyanate polyaddition products (ii), usually polyurethane products and, if desired, polyisocyanurate products, in particular polyurethane elastomers, by reacting (a) isocyanates with (b) compounds reactive toward isocyanates, in the presence of inorganic acids, of (d) catalysts and if desired (f) and/or of (e) auxiliaries and/or additives and/or (c) has been described many times.

Examples of the starting materials (a), (b), (c), e) and (f) for the novel process are given below:

Possible isocyanates (a) are the aliphatic, cycloaliphatic, araliphatic and/or aromatic isocyanates known per se, preferably diisocyanates, which may have been biuretized and/or isocyanuratized by well-known processes. Individual examples are: alkylene diisocyanates having from 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate, lysin ester diisocyanate (LDI), hexamethylene 1,6-diisocyanate (HDI), cyclohexane 1,3- and/or 1,4-diisocyanate, hexahydrotolylene 2,4- and 2,6-diisocyanate, and also the corresponding isomer mixtures, dicyclohexylmethane 4,4′-, 2,2′- and 2,4′-diisocyanate, and also the corresponding isomer mixtures, 1-isocyanato-3,3,5-trimethyl-5-isocyanatomethylcyclohexane (IPDI), tolylene 2,4- and/or 2,6-diisocyanate (TDI), diphenylmethane 4,4′-, 2,4′- and/or 2,2′-diisocyanate (MDI), polyphenylpolymethylene polyisocyanate and/or mixtures comprising at least two of the isocyanates mentioned. Use may also be made in the novel process of di- and/or polyisocyanates containing ester groups, urea groups, allophanate groups, carbodiimide groups, uretdione groups and/or urethane groups. Use is preferably made of 2,4′-, 2,2′- and/or 4,4′-MDI and/or of polyphenylpolymethylene polyisocyanates, particularly preferably of mixtures comprising polyphenylpolymethylene polyisocyanates and at least one of the MDI isomers.

Examples of compounds (b) which may be used and are reactive toward isocyanates are those in which the group(s) reactive toward isocyanates is/are hydroxyl, thiol and/or primary and/or secondary amino, and which generally have molar mass of from 60 to 10 000 g/mol, for example polyols selected from the group consisting of polyether polyalcohols, polyester polyalcohols, polythioether polyols, hydroxy-containing polyacetals and hydroxyl-containing aliphatic polycarbonates, and mixtures made from at least two of the polyols mentioned. These compounds usually have a functionality of from 2 to 6, and preferably have a molecular weight of from 400 to 8000. They are known to the skilled worker.

Examples of polyether polyalcohols are those which are obtainable using known technology by adding alkylene oxides, such as tetrahydrofuran, propylene 1,3-oxide, butylene 1,2- or 2,3-oxide, styrene oxide and preferably ethylene oxide and/or propylene 1,2-oxide, to conventional starter substances. Examples of starter substances which may be used are known aliphatic, araliphatic, cycloaliphatic and/or aromatic compounds containing at least one, preferably 2 to 4, hydroxyl group(s) and/or at least one, preferably 2 to 4, amino group(s). Examples of compounds which may be used as starter substances are ethanediol, diethylene glycol, 1,2- and 1,3-propanediol, 1,4-butanediol, 1,5-pentanediol, 1,6-hexanediol, 1,7-heptanediol, glycerol, trimethylolpropane, neopentyl glycol, sugars, such as sucrose, pentaerythritol, sorbitol, ethylenediamine, propanediamine, neopentanediamine, hexamethylenediamine, isophoronediamine, 4,4′-diaminodicyclohexylmethane, 2-(ethylamino)ethylamine, 3-(methylamino)propylamine, diethylenetriamine, dipropylenetriamine and/or N,N′-bis(3-aminopropyl)ethylenediamine.

The alkylene oxides may be used individually or alternating in succession, or as mixtures. Preference is given to the use of alkylene oxides which give primary hydroxyl groups in the polyol. Particular preference is given to the use of polyols which have been alkoxylated with ethylene oxide at the end of the alkoxylation and therefore have primary hydroxyl groups.

Polymer polyols are a specific class of polyether polyols, and use may be made of well known compounds from polyurethane chemistry, preferably styrene-acrylonitrile graft polyols.

Specifically, the use of polymer polyols can markedly decrease the shrinkage of the polyisocyanate polyaddition product, for example of the polyurethane, and thus lead to improved adhesion of (ii) to (i) and (iii). Other preferred measures which may be taken, where appropriate, to reduce shrinkage are the use of blowing agents (f) and/or gases (c).

Suitable polyester polyols may be prepared, for example, from organic dicarboxylic acids having from 2 to 12 carbon atoms, preferably aliphatic dicarboxylic acids having from 4 to 6 carbon atoms, and polyhydric alcohols, preferably diols, having from 2 to 12 carbon atoms, preferably from 2 to 6 carbon atoms. The polyester polyols preferably have a functionality of from 2 to 4, in particular from 2 to 3, and a molecular weight of from 480 to 3000, preferably from 600 to 2000, in particular from 600 to 1500.

The novel composite elements are preferably produced using polyether polyalcohols as components (b) for the reaction with the isocyanates, advantageously those with an average functionality toward isocyanates of from 1 to 8, preferably from 1.5 to 8, and with molecular weight of from 400 to 8000.

The use of polyether polyalcohols offers considerable advantages by way of improved resistance of the polyisocyanate polyaddition products to hydrolytic cleavage, and due to their lower viscosity, in each case compared with polyester polyalcohols. The improved resistance to hydrolysis is particularly advantageous for use in ship building. The lower viscosity of the polyether polyalcohols and of the reaction mixture for producing (ii) comprising the polyether polyalcohols permits simpler and more rapid filling of the space between (i) and (iii) with the reaction mixture for producing the composite elements. Low-viscosity liquids give a considerable advantage in shipbuilding since the dimensions, in particular of structural components, are substantial.

Other suitable compounds reactive toward isocyanates are substances which have a hydrocarbon skeleton having from 10 to 40 carbon atoms and from 2 to 4 groups reactive toward isocyanates. For the purposes of the invention, a hydrocarbon skeleton is a succession of carbon atoms which is uninterrupted and not, as is the case for example with ethers, interrupted by oxygen atoms. Substances of this type which can be used, also referred to below as (b3), are castor oil and derivatives thereof, for example.

Other compounds which are reactive toward isocyanates and which, in addition to the abovementioned compounds with a usual molecular weight of from 400 to 8000, may be used if desired as chain extenders and/or crosslinking agents in the novel process are diols and/or triols with molecular weights of from 60 to <400. It may moreover prove advantageous for modifying mechanical properties, such as hardness, to add chain extenders, crosslinking agents or, if desired, mixtures of these. The chain extenders and/or crosslinking agents preferably have a molecular weight of from 60 to 300. Examples of possible compounds are aliphatic, cycloaliphatic and/or araliphatic diols having from 2 to 14 carbon atoms, preferably from 4 to 10 carbon atoms, for example ethylene glycol, 1,3-propanediol, 1,10-decanediol, o-, mor p-dihydroxycyclohexane, diethylene glycol, dipropylene glycol and preferably 1,4-butanediol, 1,6-hexanediol and is(2-hydroxyethyl)hydroquinone, triols, such as 1,2,4- and 1,3,5-trihydroxycyclohexane, glycerol and trimethylolpropane, low-molecular-weight polyalkylene oxides containing hydroxyl groups and based on ethylene oxide and/or on propylene 1,2-oxide and on the abovementioned diols and/or triols as starter molecules and/or diamines such as, for example, diethyltoluenediamine and/or 3,5-dimethylthio-2,4-toluenediamine.

If chain extenders, crosslinking agents or mixtures thereof are used for preparing the polyisocyanate polyaddition products, these are usefully used in amounts of from 0 to 30% by weight, preferably from 1 to 30% by weight, based on the weight of all of the compounds (b) used which are reactive toward isocyanates.

Other compounds which may be used as (b) in order to optimize the progress of curing during the production of (ii) are aliphatic, araliphatic, cycloaliphatic and/or aromatic carboxylic acids. Examples of carboxylic acids of this type are formic acid, acetic acid, 2-ethylhexanoic acid, succinic acid, oxalic acid, malonic acid, glutaric acid, adipic acid, citric acid, benzoic acid, salicylic acid, phenylacetic acid, phthalic acid, toluenesulfonic acid, and derivatives of the acids mentioned, isomers of the acids mentioned and any desired mixture of the acids mentioned. The proportion of these acids by weight may be from 0 to 5% by weight, preferably from 0.2 to 2% by weight, based on the total weight of (b).

The performance with regard to completion of the curing of the reaction mixture for preparing (ii) can also be improved by using amine-started polyether polyalcohols. Like the other components for preparing (ii), the compounds (b) used preferably have a very low content of water, in order to avoid formation of carbon dioxide by a reaction of the water with isocyanate groups.

Components (c) used for producing (ii) may be well known compounds whose boiling point at a pressure of 1 bar is below −50° C., such as air, carbon dioxide, nitrogen, helium and/or neon. It is preferable to use air. Component (c) is preferably inert toward component (a), particularly preferably toward components (a) and (b), i.e. there is hardly any, and preferably no, detectable reactivity of the gas toward (a) or (b). The use of the gas (c) differs fundamentally from the use of conventional blowing agents for producing foamed polyurethanes. Whereas conventional blowing agents (f) are used in liquid form or, in the case of gaseous physical blowing agents have solubility of a few percent in the polyol component), and whereas these blowing agents either evaporate due to heat generation or else, in the case of water, evolve gaseous carbon dioxide due to reaction with the isocyanate groups, components (c) in the present invention is preferably gaseous before it is used, in the form of an aerosol, for example, in the polyol component.

If desired, additives and/or auxiliaries (e) may be incorporated into the reaction mixture for preparing the polyisocyanate polyaddition products (ii). Examples which may be mentioned are surface-active substances, fillers, dyes, pigments, flame retardants, agents to protect against hydrolysis, and substances with fungistatic or bacteriostatic action and foam stabilizers.

Examples of possible surface-active substances are those compounds which serve to promote the homogenization of the starting materials and where appropriate, are also suitable for regulating the cell structure of the plastics. Examples which may be mentioned are emulsifiers, such as the sodium salts of castor oil sulfates or of fatty acids, and also salts of fatty acids with amines, e.g. diethylammonium oleate, diethanolammonium stearate, diethanolammonium ricinoleate, and salts of sulfonic acids, e.g. the alkali metal or ammonium salts of dodecylbenzeneor dinaphthylmethanedisulfonic acid and ricinoleic acid. The surface-active substances are usually used in amounts of from 0.01 to 5% by weight, based on 100% by weight of the total of compounds (b) used which are reactive toward isocyanates.

Examples of suitable flame retardants are tricresyl phosphate, tris(2-chloroethyl) phosphate, tris(2-chloropropyl) phosphate, tris(1,3-dichloropropyl) phosphate, tris(2,3-dibromopropyl) phosphate, tetrakis(2-chloroethyl) ethylenediphosphate, dimethyl methanephosphonate, diethyl diethanolaminomethylphosphonate and also commercially available halogen-containing flame-retardant polyols. The compounds which may be used to provide flame retardancy to the polyisocyanate polyaddition products are, besides the abovementioned halogen-substituted phosphates, inorganic or organic flame retardants such as red phosphorus, alumina hydrate, antimony trioxide, arsenic oxide, ammonium polyphosphate and calcium sulfate, expandable graphite or cyanuric acid derivatives, e.g. melamine, or mixtures of at least two flame retardants, e.g. ammonium polyphosphates and melamine, and also, if desired, maize starch or ammonium polyphosphate, or melamine and expandable graphite and/or, if desired, aromatic polyesters. It has generally proven useful to use from 5 to 50% by weight, preferably from 5 to 25% by weight, of the flame retardants mentioned, based on the weight of all of the isocyanate-reactive compounds used.

For the purposes of the invention, fillers, in particular reinforcing fillers, are reinforcing agents, weighting agents, agents to improve abrasion performance in paints, coating agents, etc., and the usual organic and inorganic fillers known per se. Individual examples which may be mentioned are: inorganic fillers, such as silicate minerals, for example phyllosilicates, such as antigorite, serpentine, hornblends, amphiboles, chrysotile and talc, metal oxides, such as kaolin, aluminas, titanium oxides and iron oxides, metal salts, such as chalk, barite and inorganic pigments, such as cadmium sulfide and zinc sulfide, and also glass. Preference is given to the use of kaolin (china clay), aluminum silicate and coprecipitates of barium sulfate and aluminum silicate, and also to natural and synthetic fiber-forming minerals, such as wollastonite and short metal and glass fibers. Examples of possible organic fillers are: carbon, melamine, rosin, cyclopentadienyl resins and graft polymers, and also cellulose fibers, polyamide fibers, polyacrylonitrile fibers, polyurethane fibers, and polyester fibers based on aromatic and/or on aliphatic dicarboxylic esters, and in particular carbon fibers. The inorganic and organic fillers may be used individually or as mixtures.

The auxiliaries (e) and/or additives used in producing (ii) preferably comprise from 10 to 70% by weight of fillers, based on the weight of (ii). The fillers used preferably comprise talc, kaolin, calcium carbonate, barite, glass fibers and/or glass microbeads. The size selected for the particles in the fillers is preferably such as not to impede introduction into the space between (i) and (iii) of the components for producing (ii). The fillers particularly preferably have particle sizes of <0.5 mm.

It is preferable for the fillers to be used in a mixture with the polyol component in the reaction to prepare the polyisocyanate polyaddition products.

The fillers may serve to reduce the coefficient of thermal expansion of the polyisocyanate polyaddition products, which is greater than that of steel, for example, and thus to match this coefficient to that of the steel. This is particularly advantageous for a durably strong bond between layers (i), (ii) and (iii), since it results in lower stresses between the layers when they are subjected to thermal load.

It is preferable for conventional commercially available foam stabilizers well known to the skilled worker to be used as (e) for producing (ii), for example well known polysiloxane-polyoxyalkylene block copolymers, e.g. Tegostab 2219 from Goldschmidt. When producing (ii), the proportion of these foam stabilizers is preferably from 0.001 to 10% by weight, particularly preferably from 0.01 to 10% by weight, and in particular from 0.01 to 2% by weight, based on the weight of the components (b), (e) and, if used, (d) used to produce (ii). The use of these foam stabilizers stabilizes the preferred component (c) in the reaction mixture for producing (ii).

Blowing agents well known in polyurethane chemistry may be used as blowing agents (f), for example physical and/or chemical blowing agents. These physical blowing agents generally have a boiling point above −50° C. at a pressure of 1 bar. Examples of physical blowing agents are CFCs, HCFCs, HFCs, aliphatic hydrocarbons, cycloaliphatic hydrocarbons, for example in each case those having from 4 to 6 carbon atoms, and mixtures of these substances, for example trichlorofluoromethane (boiling point 24° C.), chlorodifluoromethane (boiling point −40.8° C.), dichlorofluoroethane (boiling point 32° C.), chlorodifluoroethane (boiling point −9.2° C.), dichlorotrifluoroethane (boiling point 27.1° C.), tetrafluoroethane (boiling point −26.5° C.), hexafluorobutane (boiling point 24.6° C.), isopentane (boiling point 28° C.), n-pentane (boiling point 36° C.), and cyclopentane (boiling point 49° C.).

Examples of chemical blowing agents which may be used, i.e. blowing agents which use a reaction, for example with isocyanate groups, to form gaseous products, are water, compounds in which water of hydration is present, carboxylic acid, tert-alcohols, e.g. tert-butanol, and carbamates, for example the carbamates described in EP-A 1000955, in particular in lines 5 to 31 on page 2 and lines 21 to 42 on page 3, carbonates, e.g. ammonium carbonate, and/or ammonium hydrogen carbonate, and/or guanidine carbamate.

Water and/or carbamates are preferably used as blowing agents (f).

The amount preferably used of the blowing agents (f) is sufficient to obtain the preferred density of (ii). This can be determined using simple routine experiments very familiar to the skilled worker. The amount of the blowing agents (f) used is particularly preferably from 0.05 to 10% by weight, in particular from 0.1 to 5% by weight, based in each case on the total weight of the polyisocyanate polyaddition products.

By definition, the weight of (ii) corresponds to the weight of the components (a), (b), and (c), and, where appropriate, (d), and/or (e).

To prepare the polyisocyanate polyaddition products according to the invention, the amounts reacted of the isocyanates and of the compounds reactive toward isocyanates are preferably such that the ratio of equivalents of NCO groups in the isocyanates to the total of the reactive hydrogen atoms in the compounds reactive toward isocyanates (b) and, where appropriate, (f) is from 0.85 to 1.25:1, preferably from 0.95 to 1.15:1 and in particular from 1 to 1.05:1. If (ii) contains at least some isocyanurate groups, the ratio used between NCO groups and the total of the reactive hydrogen atoms is usually from 1.5 to 60:1, preferably from 1.5 to 8:1.

The polyisocyanate polyaddition products are usually prepared by the one-shot process or by the prepolymer process, for example with the aid of high-pressure or low-pressure technology.

It has proven particularly advantageous to operate by the two-component process and to combine the compounds (b) reactive toward isocyanates, where appropriate the blowing agents (f), and, where appropriate, the catalysts (d), and/or auxiliaries and/or additives (e) in component (A) and preferably to mix these intimately with one another, and to use the isocyanates (a) as component (B).

The preferred component (c) may be introduced into the reaction mixture comprising (a), (b) and, if used, (f), (d) and/or (e), and/or into the individual components described above (a) and (b), or into (A) and/or (B). The component with which (c) is mixed is usually liquid. It is preferable for the components to be mixed into component (b).

The mixing of the appropriate component with (c) may take place by well known processes. For example, (c) may be introduced into the appropriate component by way of well known feeding equipment, such as air-feeding equipment, preferably under pressure, for example from a pressure vessel or compressed by a compressor, e.g. by way of a nozzle. There is preferably substantial and thorough mixing of the corresponding components with (c), and the size of the bubbles of gaseous (c) in the usually liquid component is therefore preferably from 0.0001 to 10 mm, particularly preferably from 0.0001 to 1 mm.

The content of (c) in the reaction mixture for producing (ii) may be determined by way of the density of the reaction mixture using well known measurement devices in the return line of the high-pressure machinery. The content of (c) in the reaction mixture may preferably be regulated automatically on the basis of this density, by way of a control unit. Even at very low circulation rates, the component density can be determined on-line and regulated during conventional circulation of the material within the machinery.

The sandwich element may, for example, be produced by sealing off, except for a feed and a discharge for the starting components, the space to be filled between (i) and (iii) with the starting components for producing (ii), and charging the starting components (a), (b), and, if desired, (c), (d), (f) and/or (e), preferably mixed, into the space between (i) and (iii), via the feed, preferably using conventional high-pressure machinery.

The starting components are usually mixed at from 0 to 100° C., preferably from 20 to 60° C., and, as already described, introduced into the space between (i) and (iii). They may be mixed mechanically using a stirrer or a mixing screw, but preferably by the countercurrent method usual in high-pressure machinery, in which a jet of A component and a jet of B component, each at high pressure, encounter one another in the mixing head and mix. The jet of one or other component may also have been divided. The reaction temperature, i.e. the temperature at which the reaction takes place, is usually >20° C., preferably from 50 to 150° C.

The composite elements obtainable according to the invention are therefore particularly used in sectors which need structural components which resist large forces, for example as structural components in shipbuilding, e.g. in ships' hulls, such as level hulls with an outer and an inner wall, or cargo hold covers, cargo hold partitions, or cargo doors, or in civil engineering work, such as bridges, or as structural components in the construction of buildings, in particular for multistorey buildings.

The composite elements of the invention should not be confused with traditional sandwich elements which comprise a rigid polyurethane foam and/or a rigid polyisocyanurate foam as core and are usually used for thermal insulation. The comparatively low mechanical load-bearing capacity of these known sandwich elements would make them unsuitable for the application sectors mentioned.

We claim:

1. A composite element which has the following layer structure:
(i) from 2 to 20 mm of metal,
(ii) from 10 to 300 mm of polyisocyanate polyaddition products obtainable by reacting (a) isocyanates with (b) compounds reactive toward isocyanates in the presence of at least one inorganic acid, and also of at least one catalyst (d),
(iii) from 2 to 20 mm of metal.

2. A composite element as claimed in claim 1 in which the inorganic acid present comprises phosphoric acid.

3. A composite element as claimed in claim 1 in which (d) comprises tertiary amines and/or metal catalysts.

4. A composite element as claimed in claim 1 in which (b) comprises polymer polyols.

5. A composite element as claimed in claim 1 in which (a) comprises MDI isocyanate components with functionality greater than 2.

6. A composite element as claimed in claim 1 obtainable by reaction in the presence of from 1 to 50% by volume of gases (c).

7. A composite element as claimed in claim 1 obtainable by reaction in the presence of (f) blowing agents.

8. A composite element which has the following layer structure:
(i) from 2 to 20 mm of metal,
(ii) from 10 to 300 mm of polyisocyanate polyaddition products with density from 3.0 to 1100 kg/m³ obtainable by reacting (a) isocyanates with (b) compounds reactive toward isocyanates in the presence of at least one inorganic acid, (d) catalysts, and also, where appropriate, of (f) blowing agents, and of from 1 to 50% by volume, based on the volume of the polyisocyanate polyaddition products, of at least one gas (c), and/or of (e) auxiliaries and/or additives,
(iii) from 2 to 20 mm of metal.

9. A process for producing composite elements as claimed in any of claims 1 to 8, which comprises preparing polyisocyanate polyaddition products (ii) between (i) and (iii) by reacting (a) isocyanates with (b) compounds reactive toward isocyanates in the presence of at least one inorganic acid, and also of at least one catalyst (d), where the polyisocyanate polyaddition products adhere to (i) and (iii).

10. The use of composite elements as claimed in any of claims 1 to 8 as structural components in ship building or in civil engineering works.

11. A ship or an item of civil engineering work comprising composite elements as claimed in any of claims 1 to 8.
